(19) United States
(12) Patent Application Publication
(10) Pub. No.: US 2016/0059616 A1
(43) Pub. Date: Mar. 3, 2016

(54) Multi-Functional Pencil Sharpener with Power Station

(71) Applicant: Acme United Corporation, Fairfield, CT (US)

(72) Inventors: Brian S. Olschan, Madison, CT (US); Siu-Leung Tang, Hong Kong (CN)

(21) Appl. No.: 14/825,222

(22) Filed: Aug. 13, 2015

Related U.S. Application Data
(60) Provisional application No. 62/041,889, filed on Aug. 26, 2014.

(51) Int. Cl. B43L 23/00; H02J 7/00

(52) U.S. Cl. CPC B43L 23/008; H02J 7/0052; H02J 7/0042; H02J 7/0047; H02J 2007/0062

(57) ABSTRACT

An automatic, multi-functional pencil sharpener includes a pencil sharpening mechanism and a power docking station to provide power to charge an auxiliary electronic device, such as an electronic tablet or a mobile phone. An electrical power unit distributes electricity to the externally accessible docking station and the pencil sharpening mechanism. Power from an external power source is supplied to the electrical unit. The docking station may include multiple USB charging ports.

### BACKGROUND

The present disclosure relates generally to pencil sharpeners, and more particularly, to automatic pencil sharpeners that operate on electrical power.

Conventional automatic pencil sharpeners typically have a single function—to sharpen a pencil when required. It is common for a user to leave an electric pencil sharpener plugged into an exterior power source continuously for long periods of time allowing intermittent but immediately accessible use of the pencil sharpener. As a result, the power source is unusable for other purposes. It would be advantageous to provide an automatic multi-functional pencil sharpener that provides an auxiliary function when connected to a power source.

### SUMMARY

Briefly stated, one embodiment of the present invention is directed to an automatic, multi-functional pencil sharpener having a power docking station that allows a user to connect external devices to the sharpener. The power docking station has charging ports accessible from the exterior of the pencil sharpener. The power docking station provides electricity to the external device for charging purposes while the sharpener remains connected to an exterior power source for extended periods of time.

Briefly stated, in one desktop-type embodiment, a multi-functional pencil sharpener comprises a housing assembly. A pencil sharpener mechanism is mounted to the housing assembly. The mechanism comprises a rotary blade assembly operatively connected to a motor via a safety switch. A power docking station is mounted to the housing assembly and exteriorly accessible of the housing assembly. A main control unit is configured to connect to an external power source and comprises a power control circuit communicating with the power docking station and a sharpener control circuit communicating with the sharpener mechanism.

The power docking station comprises a USB port. In one embodiment, the power docking station comprises a pair of USB ports disposed in generally aligned disposition. The housing assembly has a front, and the USB ports and a status LED indicator are disposed at the front.

The pencil sharpener mechanism may be disposed in upright relationship to define an opening at the top for inserting a pencil. In one embodiment, three angularly spaced USB ports are provided for charging purposes. One of the ports is configured to support a charge of approximately 2.1 amps. The USB ports are preferably disposed at the front of the housing assembly, and an inlet power port for a power cord adaptor is disposed at the rear of the housing assembly.

A mobile electronic device is connected to one of the charging ports for charging when the main control unit connects with the external power source. Both a mobile electronic device and an electronic tablet may be charged when the main control unit is connected to an external power source.

### BRIEF DESCRIPTION OF THE DRAWINGS

FIG. 1 is a block diagram of a representative embodiment of an automatic, multi-functional pencil sharpener in accordance with the present disclosure;

FIG. 2 is a partly diagrammatic, front elevational view of the automatic, multi-functional pencil sharpener of FIG. 1;

FIG. 3 is a partly diagrammatic, rear elevational view of the automatic, multi-functional pencil sharpener of FIG. 1;

FIG. 4 is a top plan view of the automatic, multi-functional pencil sharpener of FIG. 1;

FIG. 5 is a front elevational view of a second embodiment of a multi-functional pencil sharpener;

FIG. 6 is a rear elevational view of the multi-functional pencil sharpener embodiment of FIG. 5;

FIG. 7 is a representative functional block diagram for into the multi-functional pencil sharpener embodiment of FIG. 5;

FIG. 8 is an annotated schematic diagram of the motor control circuit for the block diagram of FIG. 7; and

FIG. 9 is an annotated schematic diagram of a charging port management circuit for the block diagram of FIG. 7.

### DETAILED DESCRIPTION

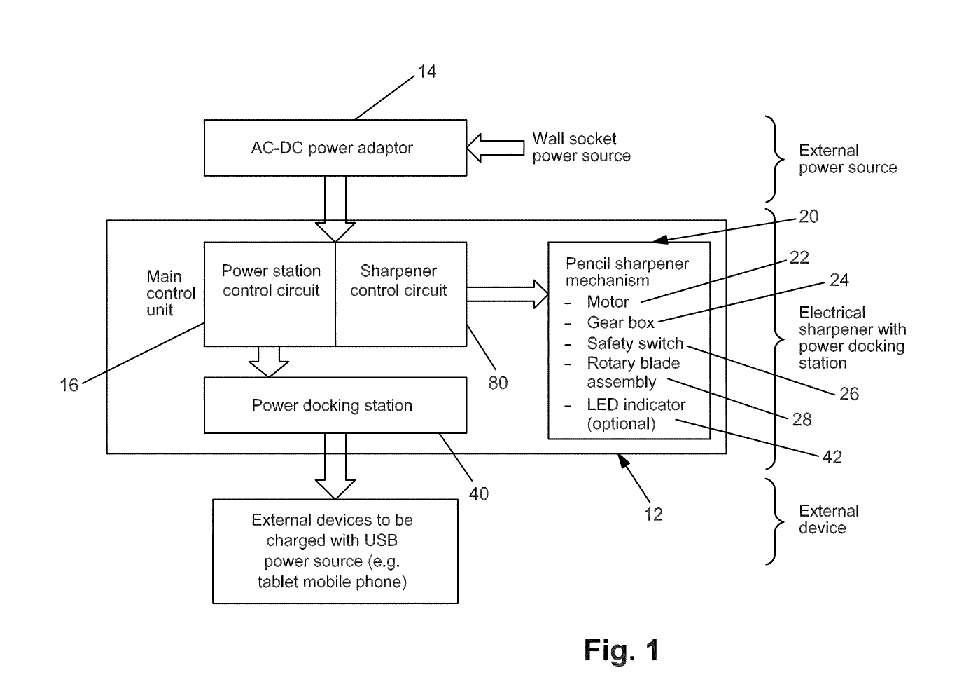

Referring to FIGS. 1-4, wherein like numerals indicate like elements throughout, there is shown a representative embodiment of an automatic multi-functional pencil sharpener 10. The multi-functional pencil sharpener 10 in accordance with the present disclosure in one general function automatically sharpens pencils to a predetermined sharpness and is electrically powered. The multi-functional pencil sharpener is preferably adapted to be positioned on a desktop or other horizontal surface in an upright orientation for use as needed.

Referring to FIG. 1, multi-functional sharpener 10 incorporates many of the features disclosed in U.S. Pat. No. 8,196,624, the disclosure of which is incorporated by reference in its entirety. The multi-functional pencil sharpener 10 includes a main control unit 12 which is connected to an external power source. This connection includes an AC-DC power adaptor 14 configured to connect to a power source, such as a wall socket. The main control unit 12 contains a power station control circuit 16 and a sharpener control circuit 18.

Various means of allocating power between circuits 16 and 18 are possible. In one embodiment, the circuits are configured such that the electric current from the external power source is routed entirely to either the power station control circuit 16 or the sharpener control circuit 18 and is changed via a load limiter, switching circuit, or the like (not illustrated). Alternatively, the circuits may also be configured such that the electric current is constantly divided between the power station control circuit 16 and the sharpener control circuit 18. In an alternate embodiment, the amount of electricity provided to the power station control circuit 16 and the sharpener control circuit 18 is adjusted—depending on the power needs of each.

The sharpener control circuit 18 is connected to a pencil sharpener mechanism 20. The pencil sharpener mechanism 20 contains a motor 22, a gearbox 24, a safety switch 26, and a rotary blade assembly 28. The motor 22 provides, through the gearbox 24, a rotatable drive for the rotary blade assembly 28. The safety switch 26 normally is in an OFF state to prevent movement of the rotary blade assembly 28. When a pencil is inserted into the pencil sharpener 10, the safety switch 26 activates to an ON state to allow movement of the rotary blade assembly 28. The safety switch 26 resumes the OFF state to stop the movement of rotary blade assembly 28 when the pencil is removed from the multi-functional pencil sharpener 10.

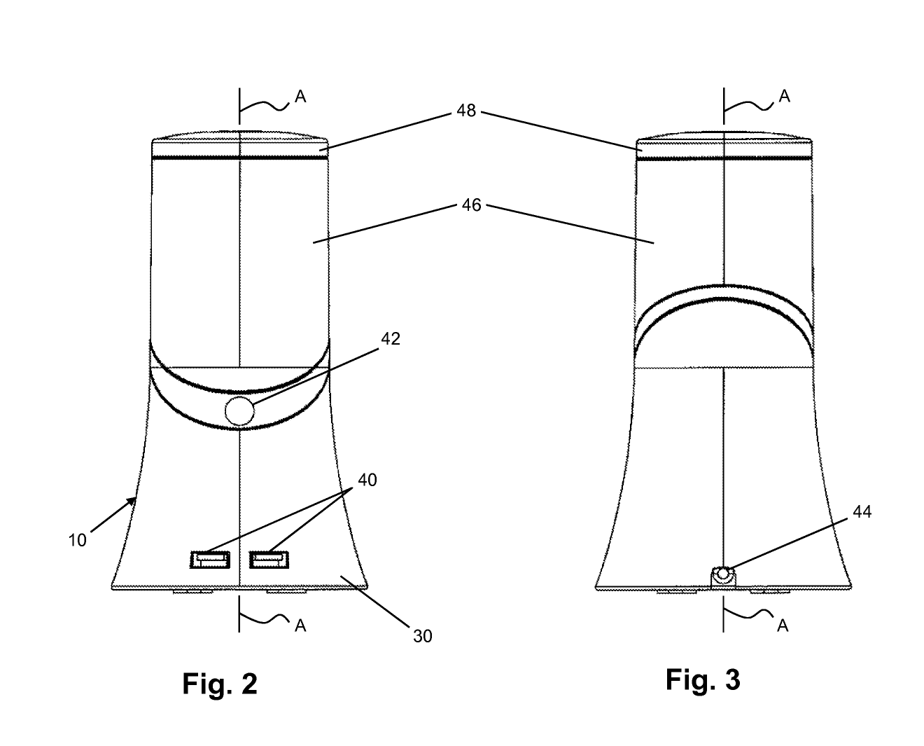

Referring to FIG. 2, the multi-functional pencil sharpener 10 includes a base 30 which houses the main control unit 12. The base 30 has a centrally located longitudinal axis A-A. The rotary blade assembly 28 may have a plurality of cutting surfaces which may be straight or curved. The rotary blade assembly 28 is supported above the base and obliquely oriented relative to axis A-A.

The power station control circuit 16 is connected to a power docking station 40. Docking station 40 is accessible from the outside of the multi-functional pencil sharpener 10, to receive a plug (not illustrated) typically at the end of a cord or cable to transmit power from the pencil sharpener 10 to a selected external device for charging purposes. The illustrated embodiment of the power docking station 40 includes two Universal Serial Bus (“USB”) sockets 41 and 43; however, various other types of charging connectors may be provided.

In one embodiment, the pencil sharpener mechanism 20 also includes an LED indicator 42 visible from the exterior of base 30. The LED indicator 42 emits a plurality of distinctive status light colors to indicate power consumption by the motor 22 or by an electronic device connected to the power docking station 40. For example, a red light illuminates when the AC/DC power adaptor 14 is plugged in, but the sharpener is inactive. A green light is illuminated when the sharpener is activated. Naturally, other indicator schemes or no illuminated indications are possible.

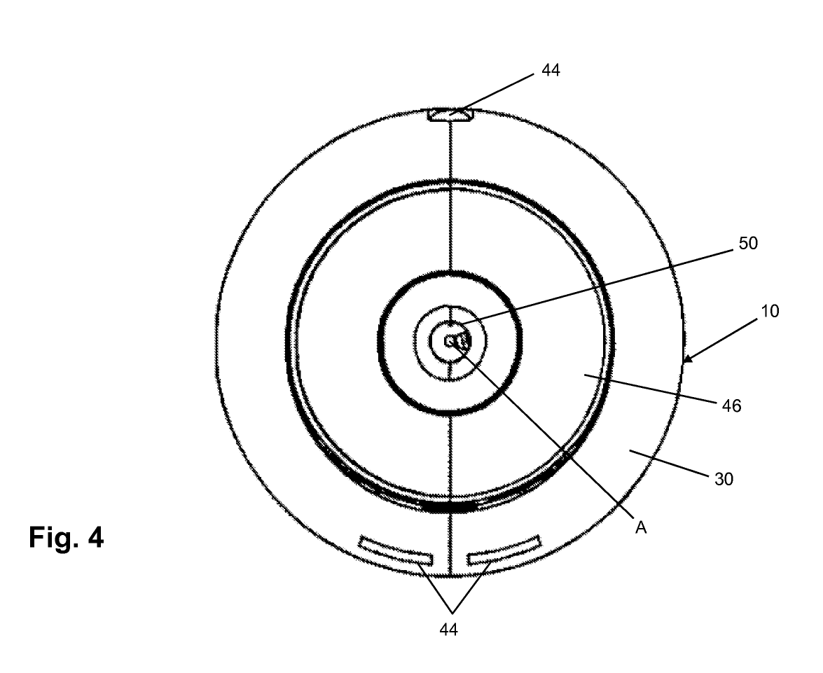

Referring to FIG. 3, the multi-functional pencil sharpener 10 receives power via an AC-DC power adaptor 14 (illustrated in FIG. 1) that is electrically connected to the main control unit through power source inlet 44.

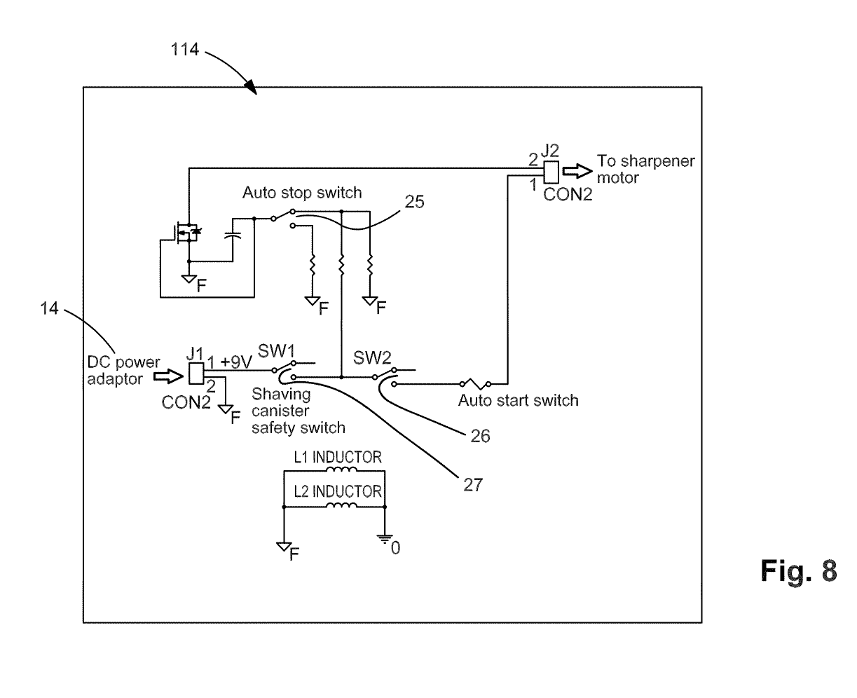

Referring to FIG. 4, the end of a pencil to be sharpened is inserted from above the pencil sharpener downwardly through the sharpening bore 50 into the multi-functional sharpener 10. Contact of the point of the pencil automatically starts the motor 22 via switch 26 (FIG. 8) which drives the rotary blade assembly 28 to sharpen the pencil in a conventional fashion. Switch 25 automatically stops the motor when the pencil is sufficiently sharpened.

One or more additional features associated with the pencil sharpening function may be provided. The shavings removed during the sharpening are forced radially outwards relative to longitudinal axis A-A by the rotational motion of the rotary blade assembly 28 and are collected in a receptacle 46. The receptacle 46 is preferably removable and sits upright on an upper rim of base 30. The receptacle 46 has a transparent cover 48 (illustrated in FIG. 3) to permit visual inspection of the quantity of retained shavings. The cover is removable from the receptacle 46. The shavings may then be removed by upwardly displacing the receptacle 46 from the base 30 and removing the cover 48. The shavings are discarded from the receptacle 46, and the receptacle is placed on the base for usage. A second safety switch 27 (FIG. 8) may prevent operation of the sharpener when the receptacle is removed from the base.

The multi-functional pencil sharpener 10 is electrically connected to an external power source via adaptor 14 at inlet 44 and concurrently to an external electronic device, such as an electronic pad, tablet or mobile smartphone, supplied by the user and connected to the power docking station 40. The main control unit 12 allows for electricity to be entirely directed to the pencil sharpener mechanism 20 or the power docking station 40 or some combination thereof. Alternatively, the main control unit 12 may vary the electricity between the pencil sharpener mechanism 20 and the power docking station 40 based on the required power of each circuit. This allows the multi-functional pencil sharpener to be readily available for sharpening a pencil while also providing an auxiliary function of supplying power to an external device through a power docking station. For example, an electronic pad, a mobile phone and/or a smartphone charger (not illustrated) may be connected to the docking station 40.

A power docking station which provides exteriorly accessible USB sockets connectable for charging auxiliary devices may also be incorporated into a pencil sharpener, such as disclosed in U.S. Pat. No. 7,546,858, the disclosure of which is incorporated herein in its entirety.

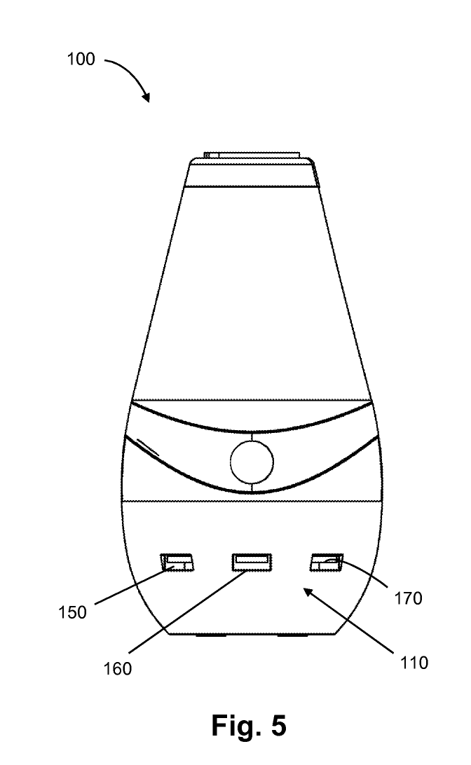

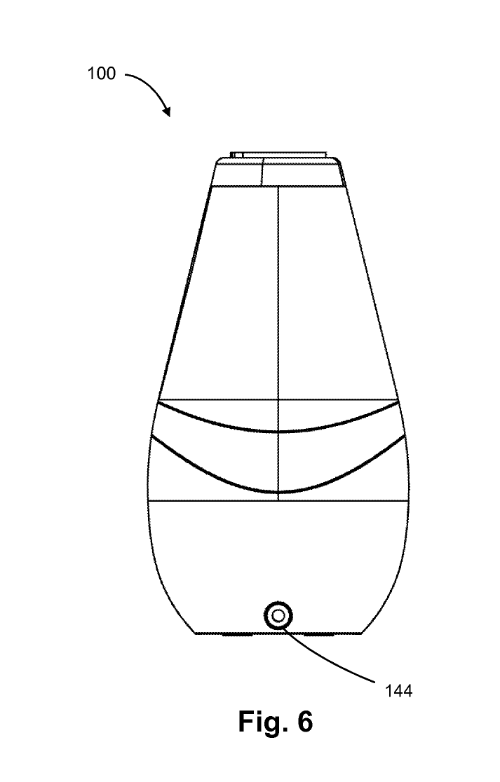

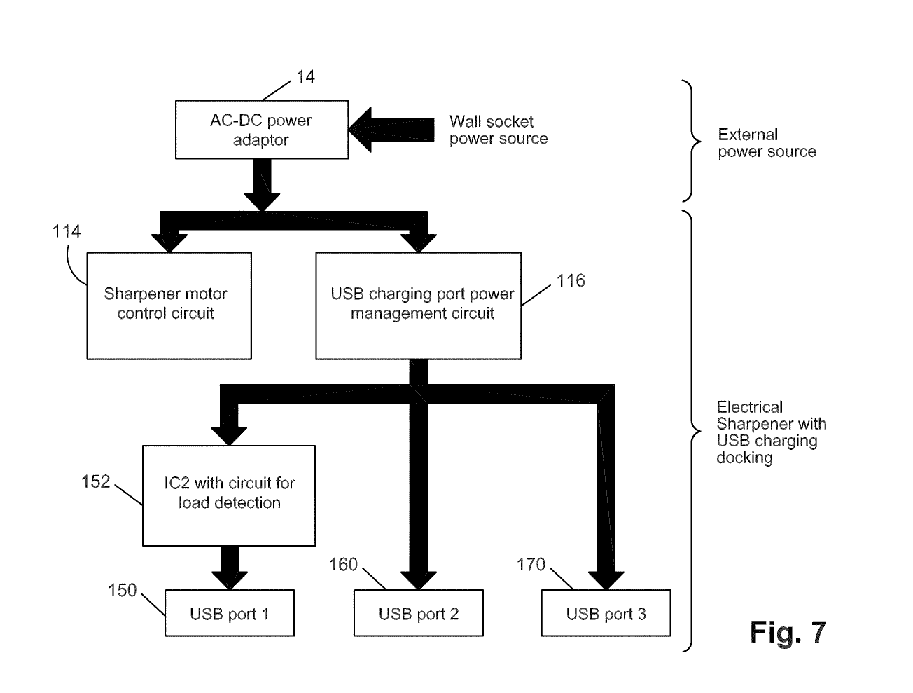

With reference to FIGS. 5-9, another embodiment of a multi-functional pencil sharpener is generally designated by the numeral 100. A power docking station generally designated by the numeral 110 is integrated with the housing. An AC/DC power adaptor 14 which is configured to connect to a power source such as connectable at a wall socket, has a sharpener motor control circuit 114 for the pencil sharpening mechanism and a USB charging port power management circuit 116 for the power docking station 110. The power control circuit connects to an exterior power source via the AC/DC adaptor 14 connecting at inlet port 144.

The control circuit 114 connects with a pencil sharpener mechanism 20. The pencil sharpener mechanism 20 contains a motor 22, a safety switch 27 and a rotary blade assembly (not illustrated). The motor 22 preferably provides through a gearbox 24, a rotatable drive for the rotary blade assembly at an upper portion of the multi-functional pencil sharpener. When a pencil is inserted into the pencil sharpener 100 from the top, the safety switch 26 activates to an ON state to drive the rotary blade assembly. The stop switch 25 stops movement of the rotary blade assembly when the pencil is removed from the pencil sharpener or the sharpening has been completed as sensed by another sensor.

The charging port management circuit 116 connects via USB ports 150, 160 and 170, which are preferably angularly arranged in the front portions of the base. In one embodiment, the USB port 150 is configured for charging an electronic pad or tablet. USB ports 160 and 170 are configured for charging a mobile smart phone. An integrated circuit 180 allocates sharing 15.5 watts of power with the three USB ports 150, 160 and 170. The circuits, circuitry and ports are configured so that the USB port 150 can charge at approximately two amps (2.1 amperes) and a mobile phone each connected to ports 160 and 170 can charge at approximately one ampere (1.0 amp) each.

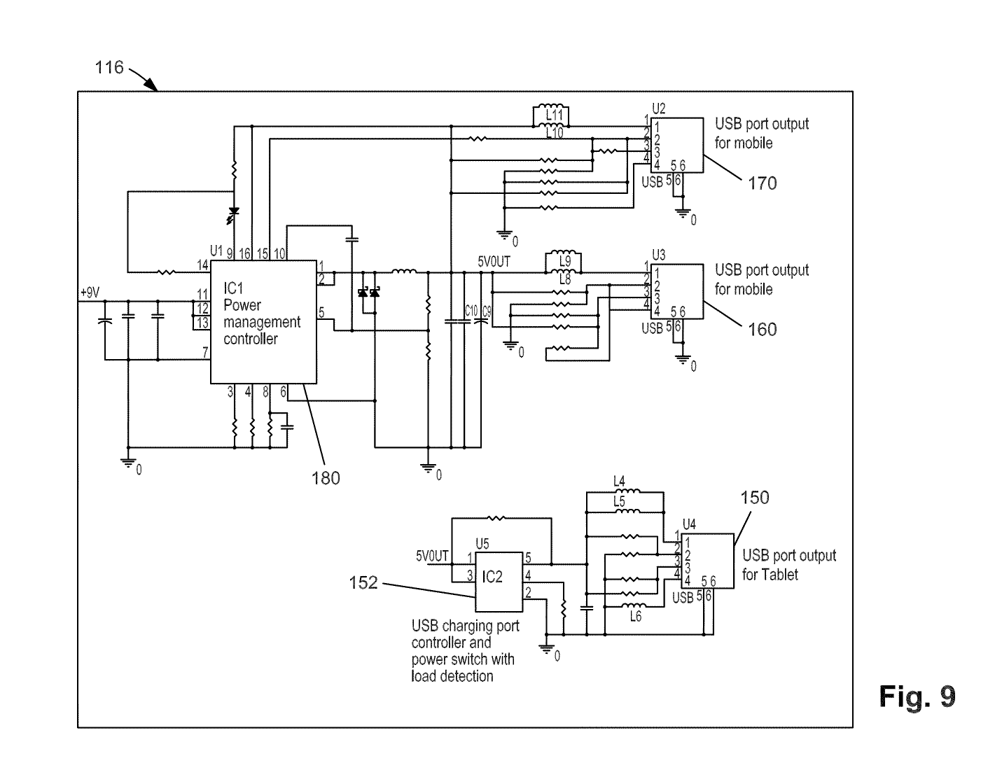

An Apple® iPad requires approximately 2.1 amps to charge at full speed. With reference to FIG. 9, in order to provide an efficient charging function for a tablet, port 150 has a special connection controlled by integrated circuit (IC) 152. The IC 152 detects the loading of the device plugged into charging plug 150 and changes the resistance between the D− and D+ pins for the specific drive to allow it to charge at the necessary current, such as, for example, 2.1 amps.

The other ports 160 and 170 connect in sub-circuits with resistor arrays to support charging at approximately 1 amp—which is suitable for most mobile devices.

While preferred embodiments of the foregoing have been set forth for purposes of illustration, the foregoing should not be deemed a limitation of the invention herein. Accordingly, various modifications, adaptations and alternatives may occur to one skilled in the art without departing from the spirit and the scope of the present invention.

1. A multi-functional pencil sharpener comprising:
a housing assembly;
a pencil sharpener mechanism mounted to said housing assembly and comprising a rotary blade assembly operatively connected to a motor via a switch;
a power docking station mounted to said housing assembly and exteriorly accessible of said housing assembly; and
a main control unit configured to connect to an external power source and comprising a power station control circuit communicating with said power docking station and a sharpener control circuit communicating with said pencil sharpener mechanism.

2. The pencil sharpener of claim 1, wherein said power docking station comprises a USB port.

3. The pencil sharpener of claim 1, wherein said power docking station comprises a pair of USB ports disposed in generally side-by-side disposition.

4. The pencil sharpener of claim 3, wherein said housing assembly has a front and said USB ports and a status LED light are disposed at the front.

5. The pencil sharpener of claim 1, wherein said pencil sharpener mechanism further comprises an LED indicator visible from the exterior of said pencil sharpener.

6. A multi-functional pencil sharpener comprising:
a housing assembly;
a pencil sharpener mechanism mounted to said housing assembly and comprising a rotary blade assembly operatively connected to a motor via a switch;
a power docking station integrated with said housing assembly and comprising at least one port exteriorly accessible of said housing assembly; and
an electrical power unit configured to connect to an external power source and comprising a power station control circuit communicating with said power docking station and a sharpener control circuit communicating with said pencil sharpener mechanism.

7. The pencil sharpener of claim 6, wherein said pencil sharpener mechanism is disposed in upright relationship and defines an opening at the top for inserting a pencil.

8. The pencil sharpener of claim 6, wherein each said port is a USB port.

9. The pencil sharpener of claim 8, wherein said power docking station comprises at least two USB ports generally disposed in aligned disposition.

10. The pencil sharpener of claim 6, wherein there are three angularly spaced ports.

11. The pencil sharpener of claim 10, wherein one of the ports is configured to support a charge of approximately 2.1 amperes.

12. The pencil sharpener of claim 8, wherein said housing assembly has a front and a rear and each said USB port is disposed at the front and an inlet power port for a power cord is disposed at the rear.

13. A multi-functional pencil sharpener comprising:
a housing assembly configured for upright disposition on a support surface;
an electrically operated pencil sharpener mechanism mounted to said housing assembly and comprising a rotary blade assembly operatively connected to a motor;
a power docking station integrated with said housing assembly and comprising a plurality of angularly spaced USB ports exteriorly accessible of said housing assembly; and
an electrical power unit configured to connect to an external power source and comprising a power management control circuit communicating with said power docking station and a sharpener control circuit communicating with said pencil sharpener mechanism.

14. The multi-functional pencil sharpener of claim 13, wherein one of said USB ports is configured to support a charge of approximately 2.1 amps.

15. The multi-functional pencil sharpener of claim 13 and further comprising a mobile electronic device connected to one said port wherein said auxiliary mobile device charges when said electrical power unit connects with an external power source.

16. The multi-functional pencil sharpener of claim 15 and further comprising an auxiliary electronic device connected to another USB port so that both said electronic devices charge when said electrical power unit is connected to an external power source.

17. The multi-functional pencil sharpener of claim 15 wherein said power management control circuit further comprises an integrated circuit for controlling a USB charging port and having a power switch with load detection.

18. The multi-functional pencil sharpener of claim 17 wherein said charging port is capable of charging a tablet at approximately 2.1 amperes.

19. The multi-functional pencil sharpener of claim 13 wherein said housing assembly defines a vertical axis and said USB ports are disposed about said axis.

20. The multi-functional pencil sharpener of claim 19 further comprising an axially disposed pencil slot.
